(19) United States
(12) Patent Application Publication
(10) Pub. No.: US 2015/0183044 A1
(43) Pub. Date: Jul. 2, 2015

(54) METHOD AND SYSTEM TO USE COMBINATION FILLER WIRE FEED AND HIGH INTENSITY ENERGY SOURCE FOR WELDING WITH CONTROLLED ARCING FREQUENCY

(71) Applicant: LINCOLN GLOBAL, INC., City of Industry, CA (US)

(72) Inventors: Steven R. Peters, Huntsburg, OH (US); William T. Matthews, Chesterland, OH (US); Judah Henry, Geneva, OH (US)

(73) Assignee: Lincoln Global, Inc., City of Industry, CA (US)

(21) Appl. No.: 14/561,904

(22) Filed: Dec. 5, 2014

Related U.S. Application Data
(63) Continuation-in-part of application No. 13/212,025, filed on Aug. 17, 2011.
Application No. 13/212,025 is a continuation-in-part of application No. 12/352,667, filed on Jan. 13, 2009, now Pat. No. 8,653,417.
(60) Provisional application No. 61/943,633, filed on Feb. 24, 2014.

(51) Int. Cl. B23K 9/10; B23K 9/173

(52) U.S. Cl. CPC B23K 9/1093; B23K 9/173

(57) ABSTRACT

Systems and methods consistent with embodiments of the present invention are directed to depositing a consumable onto a workpiece using a hot-wire welding technique which employs a combination of hot wire and arc welding. The waveform creates arc events during the hot wire welding operation to add/control heat in the welding process. The hot-wire welding process can be used by itself, with a laser or in conjunction with other welding processes.

### INCORPORATION BY REFERENCE

The present application claim priority to Provisional Application 61/943,633, filed on Feb. 24, 2014, which is incorporated herein by reference in its entirety, and the present application is a continuation-in-part of and claims priority to U.S. patent application Ser. No. 13/212,025, filed on Aug. 17, 2011, which is incorporated herein by reference in its entirety, which is a continuation in part of U.S. patent application Ser. No. 12/352,667, filed on Jan. 13, 2009, which is incorporated herein by reference in its entirety.

### TECHNICAL FIELD

Certain embodiments relate to filler wire overlaying applications as well as welding and joining applications. More particularly, certain embodiments relate to systems and methods to utilize a hot-wire deposition process with either a laser or an arc welding process.

### BACKGROUND

Recently, advances in hot-wire welding have been achieved. However, some of these processes and systems may not provide the desired or necessary heat input into the weld or overlaying operation. Thus, it is may desirable to provide additional heat into the weld or overlaying operation.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to deposit material in either an overlaying, cladding, joining or welding process using a hot-wire technique. Embodiments of the present utilize a hot-wire deposition method in which a plurality of arcing events are created between the wire and the workpiece to aid in the process. The arcing events can aid in controlling the heat input into the process, as well as increase the performance of the process, without compromising the integrity of the process.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary embodiment of a hot-wire and laser system;

FIG. 2 is a diagrammatical representation of an exemplary embodiment of a hot-wire and arc welding system;

FIG. 3 is a further diagrammatical representation of an exemplary embodiment of a hot-wire power supply and a system in which it is utilized;

FIG. 4 is a diagrammatical representation of exemplary voltage and current waveform for a hot-wire process in accordance with the present invention;

FIG. 5 is a diagrammatical representation of an exemplary hot-wire current waveform synchronized with an arc welding current waveform;

FIG. 6 is a diagrammatical representation of an exemplary waveform for hot wire welding at the beginning of the process;

FIG. 7 is a diagrammatical representation of another exemplary embodiment of a welding system of the present invention;

FIGS. 8A and 8B are diagrammatical representations of exemplary current waveforms that can be used with embodiments of the present invention;

FIG. 9 is a diagrammatical representation of another exemplary welding waveform that can be utilized by embodiments of the invention; and

FIGS. 10A and 10B are exemplary weld joint cross-sections that can be achieved with exemplary embodiments of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

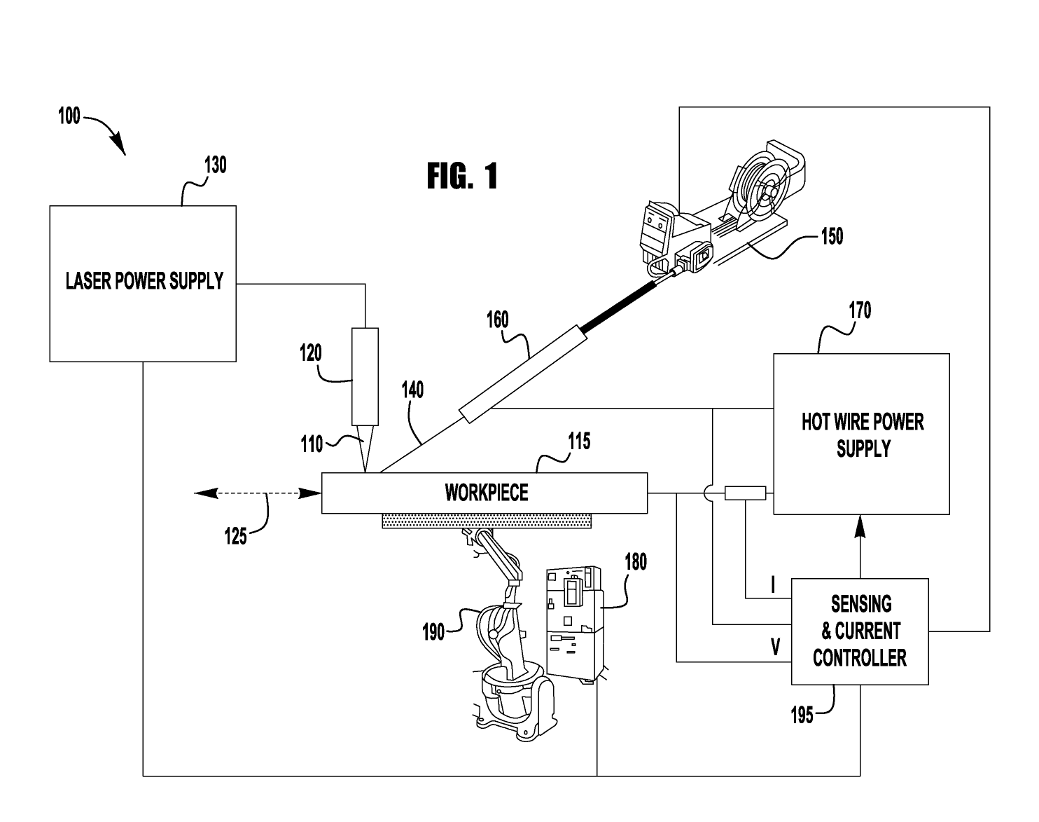

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a laser subsystem capable of focusing a laser beam 110 onto a workpiece 115 to heat the workpiece 115. The laser subsystem is a high intensity energy source. The laser subsystem can be any type of high energy laser source, including but not limited to carbon dioxide, Nd:YAG, Yb-disk, YB-fiber, fiber delivered or direct diode laser systems. Further, other types of laser systems can be used if they have sufficient energy. Other embodiments of the system may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. The following specification will repeatedly refer to the laser system, beam and power supply, however, it should be understood that this reference is exemplary as any high intensity energy source may be used. For example, a high intensity energy source can provide at least 500 W/cm². The laser subsystem includes a laser device 120 and a laser power supply 130 operatively connected to each other. The laser power supply 130 provides power to operate the laser device 120.

The system 100 also includes a hot filler wire feeder subsystem capable of providing at least one resistive filler wire 140 to make contact with the workpiece 115 in the vicinity of the laser beam 110. Of course, it is understood that by reference to the workpiece 115 herein, the molten puddle is considered part of the workpiece 115, thus reference to contact with the workpiece 115 includes contact with the puddle. The hot filler wire feeder subsystem includes a filler wire feeder 150, a contact tube 160, and a hot wire power supply 170. During operation, the filler wire 140, which leads the laser beam 110, is resistance-heated by electrical current from the hot wire welding power supply 170 which is operatively connected between the contact tube 160 and the workpiece 115. In accordance with an embodiment of the present invention, the hot wire welding power supply 170 is a pulsed direct current (DC) power supply, although alternating current (AC) or other types of power supplies are possible as well. The wire 140 is fed from the filler wire feeder 150 through the contact tube 160 toward the workpiece 115 and extends beyond the tube 160. The extension portion of the wire 140 is resistance-heated such that the extension portion approaches or reaches the melting point before contacting a weld puddle on the workpiece. The laser beam 110 serves to melt some of the base metal of the workpiece 115 to form a weld puddle and also to melt the wire 140 onto the workpiece 115. The power supply 170 provides a large portion of the energy needed to resistance-melt the filler wire 140. The feeder subsystem may be capable of simultaneously providing one or more wires, in accordance with certain other embodiments of the present invention. For example, a first wire may be used for hard-facing and/or providing corrosion resistance to the workpiece, and a second wire may be used to add structure to the workpiece.

The system 100 further includes a motion control subsystem capable of moving the laser beam 110 (energy source) and the resistive filler wire 140 in a same direction 125 along the workpiece 115 (at least in a relative sense) such that the laser beam 110 and the resistive filler wire 140 remain in a fixed relation to each other. According to various embodiments, the relative motion between the workpiece 115 and the laser/wire combination may be achieved by actually moving the workpiece 115 or by moving the laser device 120 and the hot wire feeder subsystem. In FIG. 1, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the laser beam 110 and the wire 140 effectively travel along the workpiece 115. In accordance with an alternative embodiment of the present invention, the laser device 110 and the contact tube 160 may be integrated into a single head. The head may be moved along the workpiece 115 via a motion control subsystem operatively connected to the head.

In general, there are several methods that a high intensity energy source/hot wire may be moved relative to a workpiece. If the workpiece is round, for example, the high intensity energy source/hot wire may be stationary and the workpiece may be rotated under the high intensity energy source/hot wire. Alternatively, a robot arm or linear tractor may move parallel to the round workpiece and, as the workpiece is rotated, the high intensity energy source/hot wire may move continuously or index once per revolution to, for example, overlay the surface of the round workpiece. If the workpiece is flat or at least not round, the workpiece may be moved under the high intensity energy source/hot wire as shown if FIG. 1. However, a robot arm or linear tractor or even a beam-mounted carriage may be used to move a high intensity energy source/hot wire head relative to the workpiece.

The system 100 further includes a sensing and current control subsystem 195 which is operatively connected to the workpiece 115 and the contact tube 160 (i.e., effectively connected to the output of the hot wire power supply 170) and is capable of measuring a potential difference (i.e., a voltage V) between and a current (I) through the workpiece 115 and the hot wire 140. The sensing and current control subsystem 195 may further be capable of calculating a resistance value (R=V/I) and/or a power value (P=V*I) from the measured voltage and current. In general, when the hot wire 140 is in contact with the workpiece 115, the potential difference between the hot wire 140 and the workpiece 115 is zero volts or very nearly zero volts. However, in other exemplary embodiments the voltage drop between the wire 140 and the workpiece 115 is in the range of 2 to 8 volts. As a result, the sensing and current control subsystem 195 is capable of sensing when the resistive filler wire 140 is in contact with the workpiece 115 and is operatively connected to the hot wire power supply 170 to be further capable of controlling the flow of current through the resistive filler wire 140 in response to the sensing, as is described in more detail later herein. In accordance with another embodiment of the present invention, the sensing and current controller 195 may be an integral part of the hot wire power supply 170.

In accordance with an embodiment of the present invention, the motion controller 180 may further be operatively connected to the laser power supply 130 and/or the sensing and current controller 195. In this manner, the motion controller 180 and the laser power supply 130 may communicate with each other such that the laser power supply 130 knows when the workpiece 115 is moving and such that the motion controller 180 knows if the laser device 120 is active. Similarly, in this manner, the motion controller 180 and the sensing and current controller 195 may communicate with each other such that the sensing and current controller 195 knows when the workpiece 115 is moving and such that the motion controller 180 knows if the hot filler wire feeder subsystem is active. Such communications may be used to coordinate activities between the various subsystems of the system 100.

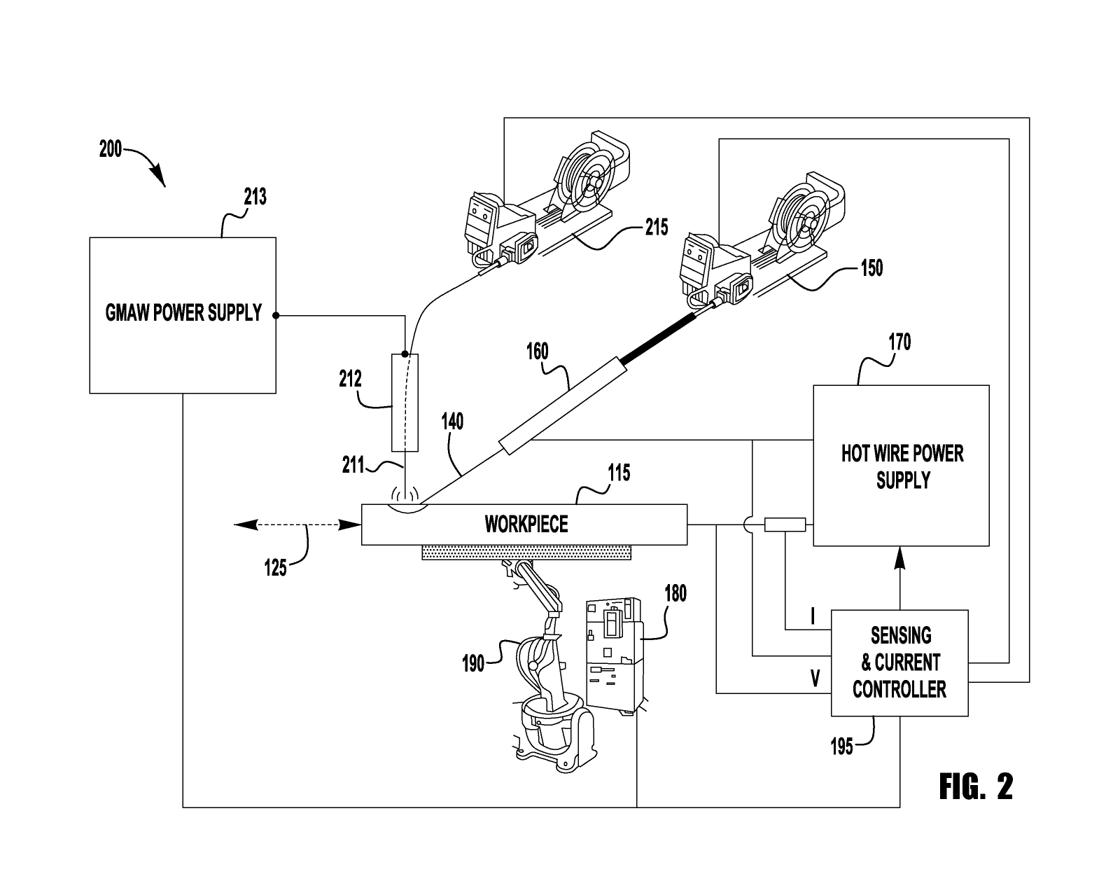

As described above, the high intensity energy source can be any number of energy sources, including welding power sources. An exemplary embodiment of this is shown in FIG. 2, which shows a system 200 similar to the system 100 shown in FIG. 1. Many of the components of the system 200 are similar to the components in the system 100, and as such their operation and utilization will not be discussed again in detail. However, in the system 200 the laser system is replaced with an arc welding system, such as a GMAW system. The GMAW system includes a power supply 213, a wire feeder 215 and a torch 212. A welding electrode 211 is delivered to a molten puddle via the wire feeder 215 and the torch 212. The operation of a GMAW welding system of the type described herein is well known and need not be described in detail herein. It should be noted that although a GMAW system is shown and discussed regarding depicted exemplary embodiments, exemplary embodiments of the present invention can also be used with GTAW, FCAW, MCAW, and SAW systems, cladding systems, brazing systems, and combinations of these systems, etc., including those systems that use an arc to aid in the transfer of a consumable to a molten puddle on a workpiece. Not shown in FIG. 2 is a shielding gas system or sub arc flux system which can be used in accordance with known methods.

Like the laser systems described above, the arc generation systems (that can be used as the high intensity energy source) are used to create the molten puddle to which the hot wire 140 is added using systems and embodiments as described in detail above. However, with the arc generation systems, as is known, an additional consumable 211 is also added to the puddle. This additional consumable adds to the already increased deposition performance provided by the hot wire process described herein. This performance will be discussed in more detail below.

Further, as is generally known arc generation systems, such as GMAW use high levels of current to generate an arc between the advancing consumable and the molten puddle on the workpiece. Similarly, GTAW systems use high current levels to generate an arc between an electrode and the workpiece, into which a consumable is added. As is generally known, many different current waveforms can be utilized for a GTAW or GMAW welding operation, such as constant current, pulse current, etc. However, during operation of the system 200 the current generated by the power supply 213 can interfere with the current generated by the power supply 170 which is used to heat the wire 140. Because the wire 140 is proximate to the arc generated by the power supply 213 (because they are each directed to the same molten puddle, similar to that described above) the respective currents can interfere with each other. Specifically, each of the currents generates a magnetic field and those fields can interfere with each other and adversely affect their operation. For example, the magnetic fields generated by the hot wire current can interfere with the stability of the arc generated by the power supply 213. That is, without proper control and synchronization between the respective currents the competing magnetic fields can destabilize the arc and thus destabilize the process. Therefore, exemplary embodiments utilize current synchronization between the power supplies 213 and 170 to ensure stable operation, which will be discussed further below.

As stated above, magnetic fields induced by the respective currents can interfere with each other and thus embodiments of the present invention synchronize the respective currents. Synchronization can be achieved via various methods. For example, the sensing and current controller 195 can be used to control the operation of the power supplies 213 and 170 to synchronize the currents. Alternatively a master-slave relationship can also be utilized where one of the power supplies is used to control the output of the other. The control of the relative currents can be accomplished by a number of methodologies including the use of state tables or algorithms that control the power supplies such that their output currents are synchronized for a stable operation. This will be discussed further below. For example, a dual-state based system and devices similar to that described in US Patent Publication No. 2010/0096373 can be utilized. US Patent Publication No. 2010/0096373, published on Apr. 22, 2010, is incorporated herein by reference in its entirety.

A more detailed discussion of the structure, use, control, operation and function of the systems 100 and 200 is set forth in the U.S. Patent Applications to which the present application claims priority (at the beginning of the present application), each of which are fully incorporated herein by reference in their entirety as they relate to the systems described and discussed herein and alternative embodiments discussed therein, which are not repeated here for efficiency and clarity.

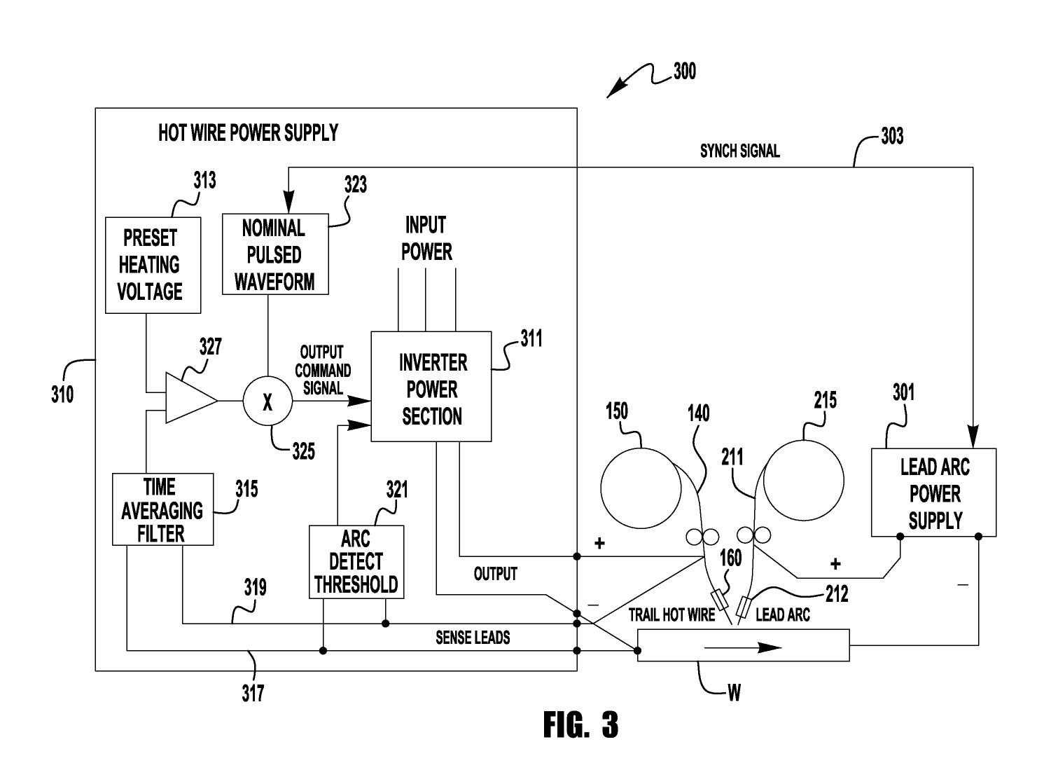

FIG. 3 depicts a schematic representation of another exemplary embodiments of a system 300 of the present invention. Like the system 200, the system 300 utilizes a combined hot-wire and arc welding process. The function and operation of the system 300 is similar to that of the system 200, and as such similar functionality will not be repeated. As shown, the system 300 comprises a leading arc welding power supply 301 which leads the trailing hot wire 140. The power supply 301 is shown as a GMAW type power supply, but embodiments are not limited to this as a GTAW type power supply can also be utilized. The welding power supply 301 can be of any known construction. Also depicted is a hot-wire power supply 310 (which can be the same as that shown in FIGS. 1 and 2) along with some of the components therein. As explained above, it may be desirable to synchronize the current waveforms output from each of the power supplies 301 and 310. As such a synchronization signal 303 can be utilized to ensure that the operation of the power supplies are synchronized, which will be further described below.

The hot-wire power supply 310 comprises an inverter power section 311 which receives input power (which can be either AC or DC) and converts the input power to an output power that is used to heat the wire 140 so that it can be deposited into a puddle on the workpiece W. The inverter power section 311 can be constructed as any known inverter type power supply which is used for welding, cutting or hot-wire power supplies. The power supply also contains a preset heating voltage circuit 313 which utilizes input data related to the process to set a preset heating voltage for the output signal of the power supply 310 so that the wire 140 is maintained at a desired temperature so that it is properly deposited onto the workpiece W. For example, the preset heating voltage circuit 313 can utilize settings such as wire size, wire type and wire feed speed to set the preset heating voltage to be maintained during the process. During operation the output heating signal is maintained such that the average voltage of the output signal, over a predetermined duration of time or number of cycles, is maintained at the preset heating voltage level. In some embodiments, the preset heating voltage level is in the range of 2 to 9 volts. Further, in exemplary embodiments of the present invention, the wire feed speed of the wire 140 can affect the optimal preset heating voltage level, such that when the wire feed speed is low (at or below 200 in/min) the preset heating voltage level is in the range of 2 to 4 volts, whereas if the wire feed speed is high (above 200 in/min) the preset heating voltage level is in the range of 5 to 9 volts. Further, in some exemplary embodiments, when the current is low (at or below 150 amps) the preset heating voltage level is in the range of 2 to 4 volts, whereas if the current is high (above 150 amps) the preset heating voltage level is in the range of 5 to 9 volts. Thus, during operation the power supply 310 maintains the average voltage between the wire 140 and the workpiece W at the preset heating voltage level for the given operation. In other exemplary embodiments, the preset heating voltage circuit 313 can set an average voltage range, where the average voltage is maintained within the preset range. By maintaining the detected average voltage at the preset heating voltage level or within the preset heating voltage range, the power supply 310 provides a heating signal which heats the wire 140 as desired, but avoiding the creation of an arc. In exemplary embodiments of the present invention, average voltage is measured over a predetermined period of time, such that a running average is determined during the process. The power supply utilizes a time averaging filter circuit 315 which senses the output voltage through the sense leads 317 and 319 and conducts the voltage averaging calculations described above. The determined average voltage is then compared to the preset heating voltage as shown in FIG. 3.

Of course, in other exemplary embodiments the power supply 310 can use current and/or power preset thresholds to control the output signal of the power supply. The operation of such systems would be similar to the voltage based control described above.

The power supply 310 also contains an arc detect threshold circuit 321 which compares the detected output voltage—through the sense leads 319 and 317—and compares the detected output voltage with an arc detection voltage level to determine an arcing event has, or will occur, between the wire 140 and the workpiece W. If the detected voltage exceeds the arc detection voltage level the circuit 321 outputs a signal to the inverter power section 311 (or a controller device) which causes the power section 311 to shut off the output power to distinguish or suppress the arc, or otherwise prevent its creation. In some exemplary embodiments the arc detection voltage level is in the range of 10 to 20 volts. In other exemplary embodiments the arc detection voltage level is in the range of 12 to 19 volts. In further exemplary embodiments, the arc detection voltage level is determined based on the preset heating voltage level and/or the wire feed speed. For example, in some exemplary embodiments, the arc detection voltage level is in the range of 2 to 5 times the preset heating voltage level. In other exemplary embodiments, the anode and cathode voltage level for any shielding gas being used can affect the preset heating voltage level. In some exemplary applications the arc detection voltage will be in the range of 7 to 10 volts, while in other embodiments it will be in the range of 14 to 19 volts. In exemplary embodiments of the present invention, the arc detection voltage will be in the range of 5 to 8 volts higher than the preset heating voltage level.

The power supply 310 also includes a nominal pulsed waveform circuit 323 which generates the waveform to be used by the inverter power section 311 to output the desired heating waveform to the wire 140 and workpiece W. As shown the nominal pulsed waveform circuit 323 is coupled to the arc welding power supply 301 via the synchronization signal 303 so that the output waveforms from each of the respective power supplies are synchronized as described herein.

As shown, the nominal pulsed waveform circuit 323 synchronizes its output signal with the arc welding power supply 301 and outputs a generated heating waveform to a multiplier which also receives an error signal from the comparator 327 as shown. The error signal allows for adjustment of the output command signal to the inverter power section 311 to maintain the desired average voltage as described above.

It should be noted that the above described circuits and basic functionality is similar to that utilized in welding and cutting power supplies and as such the detailed construction of these circuits need not be described in detail herein. Further, it is also noted that some or all of the above functionality can be accomplished via a single controller within the power supply 310.

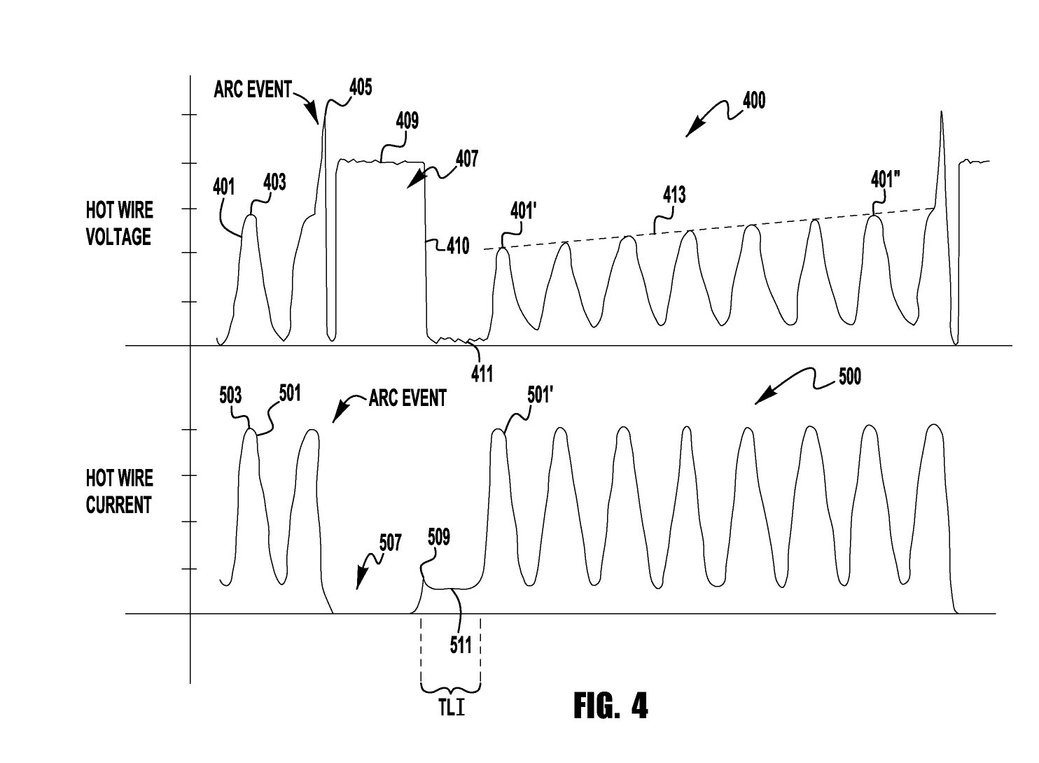

As discussed at length in the US Patent applications to which the present application claims priority, which are fully incorporated herein by reference as though the disclosures are included herein in their entirety, when using hot-wire joining and overlaying methods it is desirable to prevent the creation of an arc between the wire 140 and the puddle as the wire 140 is typically to be maintained in constant contact with the puddle. However, it has been discovered that in some hot-wire applications is may be desirable to have discrete arcing events occurring during the hot wire process to add heat to the process and puddle as desired. This is particularly true in joining or overlaying applications where at least one of the workpieces is coated, for example galvanized steel. This will be explained further below with reference to FIG. 4.

FIG. 4 depicts an exemplary voltage and current waveforms for a hot wire process as described herein. As shown, the current waveform 500 comprises a plurality of heating pulses 501 having a peak current level 503. The peak current level can be in the range of 200 to 700 amps, and the peak current level 503 is chosen to provide the desired heating and melting of the wire 140 during the process. Similarly, the voltage waveform 400 shows a plurality of voltage pulses 401 having a peak voltage 403. However, also shown is an Arc Event in which an arc is generated briefly between the wire 140 and the puddle. During the arc event the wire 140 loses contact with the puddle causing the voltage to spike to an arc level 405. At that time, the hot-wire power supply detects that an arc event has occurred and turns off the current to extinguish or suppress the arc 507. In exemplary embodiments of the present invention, the arc exists for a time within the range of 350 to 1000 microseconds. In other exemplary embodiments, the arc exists for a time within the range of 500 to 800 microseconds. With such relatively short durations for the arc, heat can be added to the puddle without causing excessive turbulence in the puddle from the arc. The power supply can use various control methodology to detect an arcing event. In exemplary embodiments of the present invention, the power supply sets a threshold value such that when the threshold value is exceeded the power supply determines that an arc event has occurred. As explained previously, in some exemplary embodiments the arc detection voltage level is in the range of 10 to 20 volts. In other exemplary embodiments the arc detection voltage level is in the range of 12 to 19 volts. In further exemplary embodiments, the arc detection voltage level is determined based on the preset heating voltage level and/or the wire feed speed.

After an arc is created, the wire 140 is no longer in contact with the puddle and gap exists between the wire 140 and the puddle. After the power supply turns off the heating current (507) the power supply then provides an open circuit voltage (OCV) 407 having a peak level 409 to the wire 140 so that the power supply is capable of detecting contact between the wire 140 and the puddle again—because the wire 140 is still being fed by the wire feeder at the puddle. In exemplary embodiments of the present invention, the OCV is in the range of 10 to 25 volts. In other exemplary embodiments, the OCV is in the range of 17 to 22 volts. The selected OCV for the operation can be based on a number of parameters, including but not limited to the wire type and wire diameter. When the wire 140 makes contact with the puddle (at 410) the power supply detects the contact (using any known contact sensing control methodology) and turns off the OCV and starts to provide a heating current to the wire 140. As shown in FIG. 4, the current can peak at an after contact peak level 509 and is then maintained at a lead-in current 511 level.

The lead-in current 509 is a relatively low current level (compared to the pulse peak levels) and is used to allow the wire 140 to reenter the puddle for a predetermined distance and to allow for pulse synchronization (discussed further below). The lead in current is maintained for a duration TLI (which will also be explained further below). The lead in current is set by the power supply and is a current level selected based on a number of factors, including any one, or all of: wire feed speed, wire type, wire diameter, hot-wire pulsing frequency, and hot-wire pulse peak 503 current levels, and can be about 1/10 of the peak current level. Typically, the lead-in current 511 is low compared to the peak 503 levels. In exemplary embodiments, the pulse peak current to lead in current ratio is in the range of 10:1 to 5:1. In exemplary embodiments, the lead in current is in the range of 25 to 100 amps, and in other embodiments is in the range of 40 to 80 amps. In other exemplary embodiments, the lead-in can be set by using a power level, as opposed to setting using a current level. In such embodiments, the lead-in power level can be in the range of 100 to 1500 watts. In additional exemplary embodiments, the lead in current 509 has a current level which is less than the average current level of the hot wire portion of the waveform—for example, as shown in FIG. 4 less than the average current for the heating pulses 501′ between arc events. In exemplary embodiments, the peak and average current of the lead in current 509 is less than the average current for the waveform 500 and the average current of the hot wire current pulses 501′ between arc events.

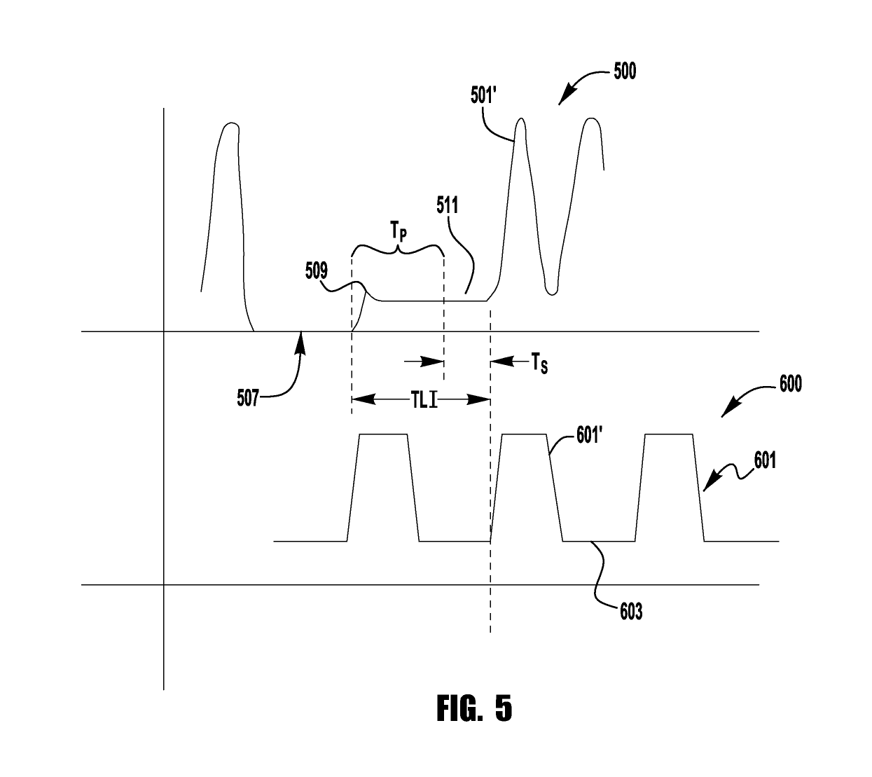

As explained above, the lead-in current is maintained for a duration TLI which allows the wire 140 to repenetrate the puddle to a desired depth. As such, the TLI is determined based on at least the wire feed speed of the wire 140. In exemplary embodiments, lead in duration TLI is in the range of 5 to 20 milliseconds, and the off time 507 is in the range of 1 to 7 milliseconds. In exemplary embodiments, the combined time for the off time 507 and the TLI is in the range of 6 to 20 milliseconds. However, as explained previously with respect to at least FIGS. 2 and 3, in some exemplary embodiments the hot-wire process is coupled with an arc welding process, such as GMAW, operating in the same puddle. In such embodiments, the lead-in duration TLI is a duration based on the wire feed speed of the wire 140 and based on the initiation of a current pulse from an arc welding process working with the hot-wire process. When using hot-wire processes coupled with arc welding processes it is desirable to synchronize the current pulses from each of the respective processes. Thus, in such embodiments the hot-wire power supply initiates the first pulse 501′ after the duration TLI only after (1) the expiration of a determined lead-in delay to allow the wire 140 to properly penetrate the puddle, and (2) to coincide with the initiation of the next arc welding pulse in the arc welding waveform. By having the duration TLI extended to satisfy these conditions, it is ensured that the wire 140 has properly penetrated the puddle to start the hot wire pulses 501 again, and that the hot-wire current waveform is properly synchronized with a concurrently used arc welding process. This is pictorially represented in FIG. 5, where the welding process utilizes a hot wire current waveform 500 synchronized with a pulsed arc welding process (for example GMAW) using the current waveform 600. As described in the priority applications referenced at the beginning of this application and fully incorporated herein, and US Patent Application titled METHOD AND SYSTEM TO USE COMBINATION FILLER WIRE FEED AND HIGH INTENSITY ENERGY SOURCE FOR WELDING, which is also fully incorporated herein by reference in its entirety, and is filed concurrently herewith, it is desirable in some applications to synchronize the pulses of the respective waveforms. Thus, in exemplary embodiments of the present invention, as shown in FIG. 5, the lead-in duration TLI is a combination of the penetration duration Tp and the synchronization duration Ts. The penetration duration Tp is determined by the hot-wire power supply, based on at least the wire feed speed of the wire 140, to ensure proper penetration of the wire 140 into the puddle and the synchronization duration Ts is the time between the expiration of the penetration duration Tp and the initiation of the next arc welding pulse 601′. That is, typically the maximum duration of the lead-in duration TLI (or lead-in period) will be the penetration duration Tp (or penetration period) and the duration of a background portion 603 of the arc welding waveform. This ensures that the wire 140 is fully penetrated into the puddle and that the two respective waveforms will be synchronized. Thus, during operation of exemplary embodiments of the present invention, the hot-wire power supply will determine a penetration duration Tp and hold the lead in current 511 at the lead in current level for that duration Tp, and after the expiration of the penetration period Tp the hot wire power supply waits for a pulse initiation signal from a controller or the arc welding power supply. Based on that initiation or synchronization signal, the hot-wire power supply initiates the first pulse 501′ following the lead in current 511 to coincide with the next pulse 601′ in the arc welding process.

It should be noted that FIG. 5 shows the two respective waveforms 500/600 having no phase shift, such that the respective pulses 501′ and 601′ will be initiated at the same time. However, other exemplary embodiments can utilize a phase shift between the current waveforms 500 and 600 such that the pulses of the respective waveforms are synchronized but phase shifted with respect to each other. In such embodiments, the lead in duration TLI will be of such a length to ensure that the pulses 501′ and 601′ are initiated at the appropriate times relative to each other, with the appropriate phase shift and after the expiration of the penetration duration. In some exemplary embodiments, the wire is allowed to penetrate the puddle by a distance which is about the same as the diameter of the wire.

As discussed previously, the arc events are used to input additional heat in the process. To accomplish this, the hot-wire power supply 170 is controlled such that the arcing events occur at a frequency in the range of 1 to 20 Hz. In other exemplary embodiments, the arcing events occur at a frequency in the range of 1 to 10 Hz. By maintaining the arcing frequency at a regular interval, additional heat can be added to the process in a controlled manner without destabilizing the hot wire, or arc welding processes. In some exemplary embodiments, the frequency of the arcing events can be adjusted to change the heat input during the process. That is, during a first portion of a process it may be desirable to use an arcing frequency of 3 Hz, while in another portion of the process it may be desirable to have an arcing frequency of 10 Hz. This the power supply 170 can control the waveforms 400/500 to achieve the desired arcing event frequency for different portions of a process, and thus provide greater control of the overall heat input of the process.

FIG. 4 also shows a plurality n of current and voltage pulses in between arcing events. As shown, the current pulses 501/501′ have a relative constant peak current level 503. That is the peak current levels of these pulses are about the same, but can differ due to the realities of the welding operation and may not be exactly the same for each pulse. However, as shown the corresponding voltage pulses have a generally increasing peak voltage 403 from a first voltage pulse 401′ (after an arcing event) to the last complete voltage pulse 401″ (after an arcing event). It has been discovered that, in some exemplary embodiments, it is desirable to allow the peak voltage level for pulses 401′ to 401″ to increase gradually between arcing events. Typically, this voltage increase occurs—at least in part—due to increasing heat in the wire 140 and in the process, which affects the overall resistance of the wire 140 and thus causes the voltage to generally rise from a first peak voltage level to a second, higher, peak voltage level over the plurality of voltage pulses between arcing events. It should be noted, that although FIG. 4 depicts the peak voltage level for the pulses 401′ through 401″ increasing from pulse-to-pulse (which is applicable for some embodiments), some exemplary embodiments are not limited to this. That is, in some exemplary embodiments, although there is a general increase in voltage over the pulses (as shown by slope 413), not every following pulse will be higher in peak voltage than its preceding pulse. In some embodiments, following pulse can have the same, or even slightly lower peak voltage than its immediately preceding pulse. However, the last pulse 401″ will have a higher peak voltage than the first pulse 401′. Further, although the embodiment shown shows a generally linear increase in peak voltage (slope 413), other embodiments are not limited to a linear voltage increase. In exemplary embodiments, the difference in peak voltage from the first voltage pulse 401′ to the last voltage pulse 401″ is in the range of 2 to 8 volts. In other exemplary embodiments, the difference is in the range of 3 to 6 volts. Further, in exemplary embodiments of the present invention, the number of voltage pulses 401′-401″ between arcing events is in the range of 8 to 22. In other exemplary embodiments, the number of voltage pulses are in the range of 12 to 18 in between arcing events.

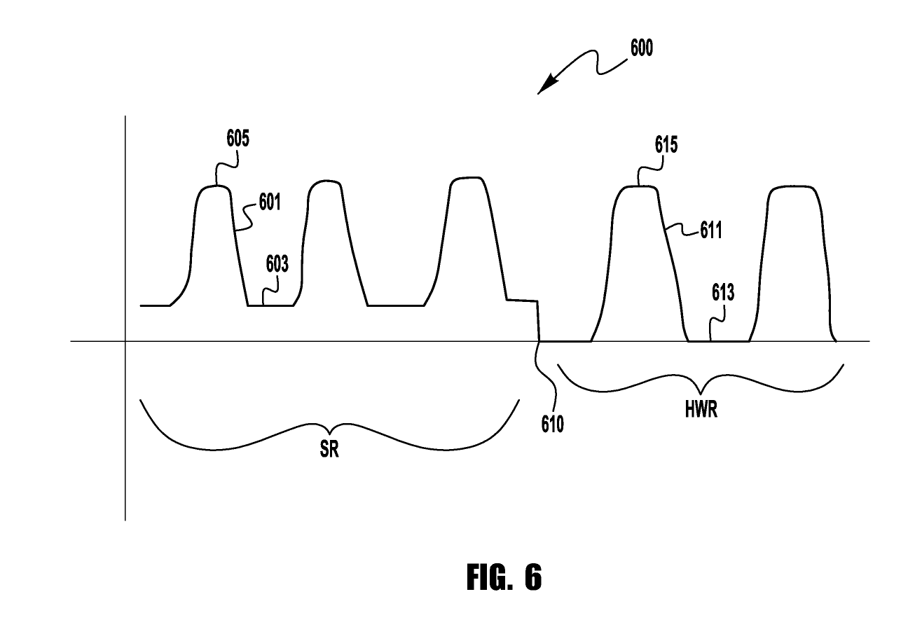

Turning now to FIG. 6, another current waveform 600 is depicted. However, this waveform 600 depicts a beginning portion of a hot wire welding process. As described previously, during hot wire welding the consumable is deposited into a puddle without an arc, while a heating current is provided to the consumable which causes the consumable to melt in the puddle. However, for this process a molten puddle is needed before the hot wire process can begin. In some situations the puddle can be created by a laser, arc from another process or some other heat source. However, in exemplary embodiments of the present invention the puddle is created using the hot wire consumable with a short pulse welding routine at the beginning of the process to establish the process. After the puddle is formed, then the hot wire process can proceed. For example, the hot wire can proceed as described herein with respect to FIG. 4, described above.

As shown in FIG. 6, the waveform 600 has a start routine portion SR and a hot wire portion HWR. The start routine portion SR can be initiated like any known arc welding operation. For example, the start routine portion SR can begin like known GMAW type welding processes to initiate the arc between the consumable and the workpiece. After the arc is created, a brief pulse welding process begins having a plurality of current pulses 601, where the pulses have a peak current level 605 and a background level 603 between the pulses 601. This is similar to known GMAW type pulse welding processes. This pulse welding process is used to create the puddle on the workpiece and is maintained for a set duration to ensure that the puddle is sufficiently created. Once the puddle is created the waveform 600 is changed from the arc welding start process SR to the hot wire portion HWR. At the end of the start routine portion SR the current is reduced or turned off (610) to extinguish the arc between the consumable and the puddle. As previously described with respect to FIGS. 4 and 5, the consumable is then advanced such that it makes contact with the puddle and the hot wire routine HWR is then initiated. As shown, in the waveform 600 the hot wire routine has a plurality of heating pulses 611, with a peak level 611 and a background level 613—which can be 0 amps in some embodiments. It is noted that the transition between the start routine portion SR and the hot wire portion HWR can be as explained above with respect to FIG. 4.

As explained above, the start routine portion is relatively short. In exemplary embodiments of the present invention, the duration of the start routine is in the range of 0.01 to 5 seconds in length, where the beginning of the duration is the time when the arc is initiated and the end of the duration is when the arc is extinguished (e.g. at 610). In further exemplary embodiments the start routine is in the range of 0.01 to 1 second. In other exemplary embodiments, the duration of the start routine is in the range of 0.1 to 0.5 seconds. In further exemplary embodiments, the power supply will transition to the hot wire routine HWR only from the background portion 603 of the start routine SR. For example, if the predetermined duration period ends in the middle of an arc pulse 601 the power supply does not simply extinguish the arc at that point but waits until the pulse 601 is completed and the welding current reaches the background portion 603 before transitioning. It is noted that in some exemplary embodiments, the wire feed speed of the consumable during the start routine can be slower than the wire feed speed during the hot wire portion of the welding process. Further, the start routine can use known arc welding processes such as short arc, STT, wire retract or other low heat input arc welding processes during the start routine. In such embodiments, excessive heat input will be avoided during start up.

In further exemplary embodiments, instead of using a time duration, the power supply uses a predetermined number of arc pulses 601 for the start routine SR and extinguishes the arc after the predetermined number of pulses is reached. For example, in exemplary embodiments, the number of pulses for the start routine is n pulse such that when n pulses is reached the power supply transitions to the hot wire routine HWR. In exemplary embodiments, the number of pulses n can be in the range of 1 to 1000 pulses. In other exemplary embodiments, the number of pulses n is in the range of 5 to 250 pulses, and in further embodiments the number of pulses can be in the range of 5 to 100 pulses. In additional exemplary embodiments, the power supply can use a combination of the time duration and number of pulses to determine the length of the start routine SR. That is, in such embodiments, the power supply uses both a set time duration and a number n of pulses, where the transition to the hot wire routine HWR does not occur until each of the duration and number of pulses has been reached, regardless of which one is reach first.

In exemplary embodiments, the duration and/or the number of pulses in the start routine portion SR is predetermined by the power supply controller based on user input information, which can include: wire feed speed, consumable size, consumable type, weld metal type, etc. In further exemplary embodiments, other factors can be used to determine the duration and/or number of pulses of the start routine, including whether or not the hot wire process is coupled with a laser, GMAW process or SAW process. In further embodiments, the type of welding/joining application can affect the parameters of the start routine, or the desired size of the puddle. For example, the puddle size may be different for high speed-thin plate processes (generally smaller puddle), heavy fabrication processes (large puddle), or cladding processes (very large puddle). In such embodiments, based on the user input information the power supply controller uses a look up table, state table, or the like to set the duration and/or number of pulses for the start routine SR to be used. The duration and/or number of pulses are to be selected to ensure a desired puddle size, depth and/or temperature is reached before the hot wire routine is initiated. In other exemplary embodiments, a system can be used to monitor the heat of the puddle and/or workpiece and/or monitor the size/shape of the puddle

As explained herein, the transition from the start routine SR to the hot wire routine HWR can be performed as described relative to FIGS. 4 and 5. However, in other exemplary embodiments the transition can occur during a short circuit condition created during the start routine. For example, if the start routine is using a process that short circuits the consumable with the puddle/workpiece the controller of the power supply can cause the transition to hot wire during a short circuit condition. This can be done when the start routine SR is using a start routine such as STT, short circuit welding or short arc welding, for example. In such embodiments, the controller monitors the duration of the start routine SR and when the desired duration and/or number of pulses has been completed the power supply transitions to hot wire at the next following short circuit event.

In other exemplary embodiments, the start routine can use a pulse welding operation, as shown in FIG. 6. However, after a predetermined duration/number of pulses the current of the pulses 601 are decreased to shorten the arc length until a short circuit event occurs. When the short occurs the transition to the hot wire process occurs. By using a short circuit event there is no need to suppress the arc artificially for the transition.

In additional embodiments, the duration of the start routine SR can be determined by monitoring the heat input during the start routine SR. For example, in such embodiments the controller/power supply will use the user input data described above to determine a desired/predetermined amount of heat input needed for the start routine SR. That is, the controller of the power supply can set a predetermined amount of heat input, and when that heat input threshold is reached the power supply can transition from the arc routine to the hot wire routine as described herein. In exemplary embodiments, the heat input threshold can be in the range of 0.01 to 10 Kj. In further exemplary embodiments, the heat input threshold can be in the range of 0.01 to 1 Kj.

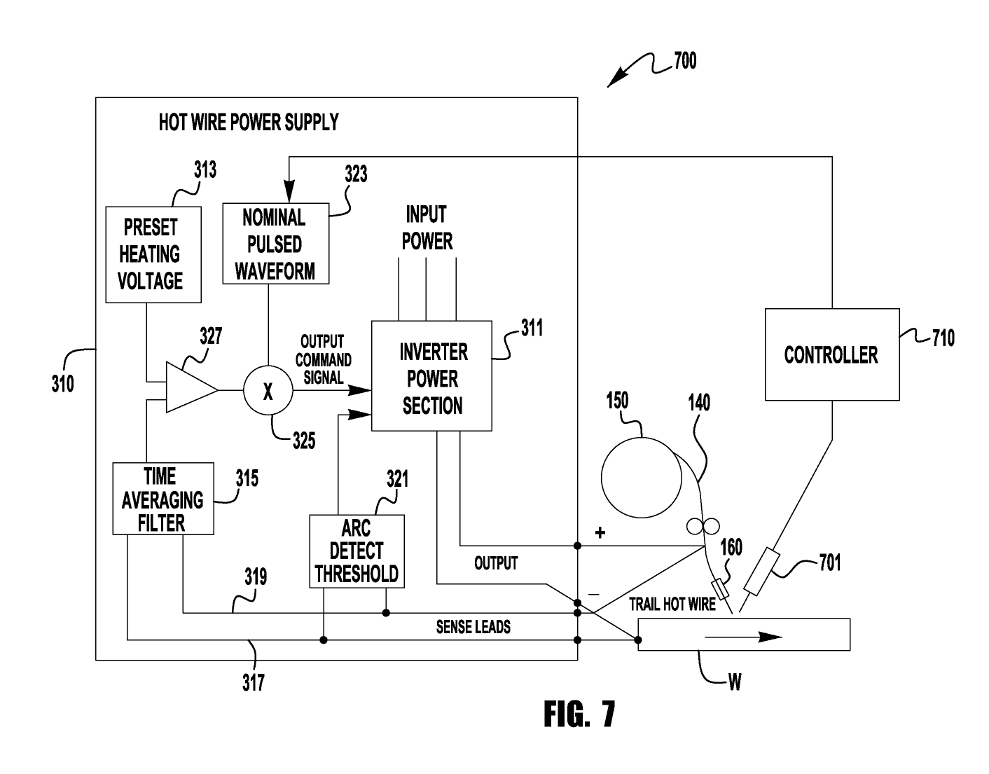

FIG. 7 depicts an additional embodiment of a system 700 having a hot wire power supply 310 as described with respect to FIG. 3. In this embodiment, the power supply 310 is coupled to a controller 710 (which can be internal to the power supply) which is coupled to a sensor device 701 which monitors the process. The sensor device 701 can be any type of sensor device that monitors the desired parameter of the puddle/workpiece. For example, the sensor device can be a thermal sensor which monitors the temperature of the puddle and/or workpiece and the feedback from the sensor device is used by the power supply 310 to control the start of the hot wire process and/or the hot wire process itself. For example, as explained with respect to FIG. 4, an arcing frequency can be coupled with the hot wire process to control the heat into the workpiece/puddle. In such embodiments, the feedback from the sensor 710 is used by the power supply to determine the appropriate arcing frequency for the hot wire current output from the power supply 310. In other embodiments, the sensor 701 can be an optical sensor which monitors the creation and size of the puddle on the workpiece and the controller 710 uses the feedback from this sensor to control the output and/or arcing frequency of the hot wire waveform. Other sensors can be used, or a combination of sensors can be used to aid in controlling the power supply 310.

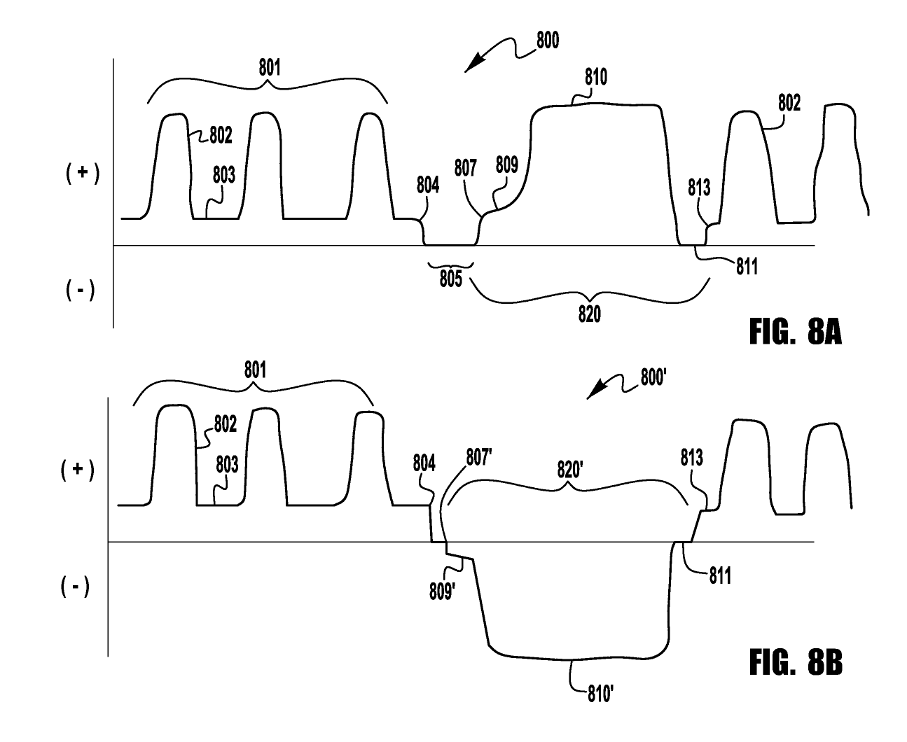

FIGS. 8A and 8B depict additional exemplary waveforms that can be used with exemplary embodiments of the present invention. As described above, the current waveforms 800 and 800′ are similar to the waveform discussed in FIG. 4. Specifically, the waveforms 800 and 800′ are combination hot wire and arcing waveforms. However, in the waveforms 800 and 800′ there is more than one arc welding pulse in between the hot wire portions. Such embodiments can be used to further control the heat input into a workpiece and/or optimize welding parameters and speed as desired. Further, such embodiments can be used on coated workpieces, such as galvanized workpieces, and achieve desirable performance without the porosity that typically comes with arc welding coated materials.

FIG. 8A depicts a current waveform 800 having an arc welding portion 801 and a hot wire portion. The arc welding portion 801 can be any known pulse welding process, such as GMAW type pulse welding processes. The arc welding portion 801 comprises a plurality of pulses 802 separated by a background current. Because GMAW type pulse welding waveforms are known, they need not be discussed in detail herein. After a period of time, or a desired number of pulses 801 have been created, the arc welding portion is ended at point 804 where the current is reduced or turned off such that the arc is extinguished and the waveform 800 transitions to a hot wire phase 820. It is noted that the transition portion between the arc welding phase and the hot wire phase can be as described relative to the waveform in FIG. 4, using a lead in current, etc. In the embodiment shown, after the arc welding current ends (804) the current is set very low or turned off during a time 805 as the consumable is being advanced toward the puddle (this is because the wire is not in contact with the puddle due to the arc welding operation as explained previously). During the off time 805 an OCV can be applied to the consumable to detect contact with the puddle. As explained previously, when contact is detected a heating current is applied (at point 807) to a lead in level 809 (which can be a lead in current level) and is maintained for a lead in time (as described previously). After the lead in, the current is increased to a heating current level 810 which is maintained to heat the consumable to ensure the consumable is melted within the puddle without an arc being created. As with the previous discussions (e.g., FIGS. 4 and 5 embodiments) the power supply uses an arc suppression control scheme during the hot wire portion 820 to ensure that no arc is created between the consumable and the workpiece, but the consumable is properly deposited into the puddle.

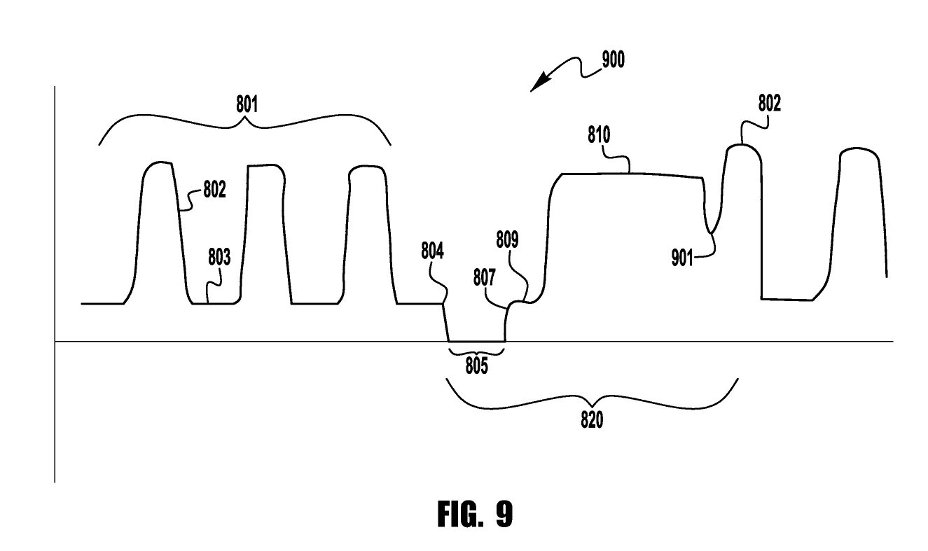

Unlike the hot wire pulses shown in FIG. 4, in FIG. 8A the hot wire current is shown as a constant current at a level 810. In such embodiments, the heating current level 810 is maintained at a desired melting level. However, in other exemplary embodiments, the hot wire portion 820 of the waveform in FIG. 8A (and FIGS. 8B and 9) can be replaced with a pulsed hot wire waveform, similar to that shown in FIG. 4. That is, in such embodiments, an arc welding portion 810 can be coupled with either a constant current or pulsed hot wire waveform for the hot wire portion 820. After a period of time, the hot wire portion 820 is stopped and transitions back to an arc welding portion 810 to perform the arc welding operation. As shown in FIG. 8A, the hot wire current drops to a reduced level, which can be 0 amps for a period of time 811 and then the arc welding current is initiated to a level 813 and then the arc welding pulses 802 begin again. Of course, any known arc welding operation can be initiated, such as pulse welding, STT type welding, short arc welding, etc. Embodiments of the present invention are not limited in this regard. Additionally, the arc welding operation which is initiated after a hot wire portion 820 of the waveform need not be the same as the arc welding operation used prior to hot wire portion. For example, a pulse welding arc welding waveform can be used preceding a hot wire portion of a waveform and following the hot wire portion 820 an STT type waveform can be used. The transition from the hot wire welding portion 820 to the arc welding portion 810 can be performed via known arc welding initiation procedures. In some exemplary embodiments, the wire feeder can slow down or withdraw the consumable so as to create a gap between the consumable and the puddle prior to arc initiation. In other exemplary embodiments, a transition routine can be initiated by the power supply to pinch off an end of the consumable and then initiate the arc. Embodiments of the present invention are not limited in this regard. As explained previously, in exemplary embodiments an STT, short arc or wire retract process can be used for the arc phase and the transition to hot wire is only during a short circuit condition.

By utilizing both hot wire and arc welding processes with the same consumable, embodiments of the present invention allow for enhanced control of heat input into a weld process, and can improve the welding performance of certain welding operations. For example, exemplary embodiments of the present invention can use a system similar to that shown in FIG. 7, in which a work piece temperature is monitor, and based on the detected temperature the controller 710 controls the waveform 800 to use the desired transfer process. That is, the controller 710 can control the ratio of arc welding to hot wire welding to control the heat input into the weld. For example, if it is determined that additional heat is needed, the control can increase the ratio of arc welding to hot wire welding in the welding waveform. Also, if the heat input is too high, the controller 710 can control the power supply 310 to decrease the amount of arc welding and increase the amount of hot wire welding for the waveform 800.

In exemplary embodiments, a ratio of the hot wire process to arc welding process is optimized to obtain a desired heat input and deposition rate. For example, in exemplary embodiments, the ratio of hot wire process to arc welding process is in the range of 50/50 to 0/100, where the ratio uses process duration. A 50/50 ratio means that 50% of the welding time is in hot wire mode, while the other 50% time is in arc welding mode. It should be noted that a ratio should be selected to ensure proper puddle formation and to ensure that proper melting of the consumable during the hot wire phase is achieved. It is also noted, that in exemplary embodiments, the ratio can be adjusted over a given period of time to obtain the desired heat input, or based on heat input feedback. It is recognized that the time the current waveform is in transition mode may not be necessarily characterized as either arc welding or hot wire, thus in such embodiments the duration of the arc welding process is determined as the duration that an arc exists, as compared to hot wire process duration—when no arc exists. Other exemplary embodiments can use other ratio relationships between the hot wire portion and arc welding portion of the process without departing from the spirit or scope of the present invention. For example, in other exemplary embodiments, a ratio of pulse counts can be used, where the ratio represents the number of hot wire pulses to arc welding pulses. In other exemplary embodiments, the ratio of pulse counts for each respective portion (hot wire v. arc welding) are maintained, but the frequency of the respective pulses are adjusted. In such embodiments, the overall durations of each respective process is adjusted because of the respective pulse frequency changes. For example, in FIG. 8A the frequency of the arc welding pulses 802 can be adjusted (e.g., increased), while the duration of the hot wire phase 820 can be maintained, such that the overall frequency or occurrence of the hot wire phase 820 will occur more frequently—the arc welding portion 801 will be shorter in duration. Other control methodologies can also be used.

In other exemplary embodiments, rather than using a sensor 710, the controller 710 uses the integral of the power of the waveform 800 to determine the overall heat input into the weld, and based on the determined heat input the controller 710 controls the arc to hot-wire ration of the waveform 800. In exemplary embodiments, the controller 710 uses user input information to determine a desired heat input for the operation and maintains this desired heat input. For example, in some embodiments, the controller 710 determines a desired running average heat and/or power input for a given operation and controls the power supply to provide that running average. The running average for heat and/or power input can be a user input or user setting, but also can be determined by the controller based on user input data. For example, the user can input any one or a combination of, workpiece material, consumable information, wire feed speed, workpiece thickness, weld size, weld position, application type (cladding, high travel speed joining, heavy deposition joining, etc.), gap size, and any build up parameters or requirements. Based on this information, the controller 710 determines a heat and/or power input threshold, which can be a running average threshold, and controls the power supply to output a waveform 800 which achieves the desired set output heat and/or power. Of course, the controller 710 can also monitor the actual heat (via the sensor 701, etc.) and/or calculate the actual power and heat provided and adjust the waveform 800 as needed to maintained the desired heat and/or power output. The controller 710 can use many different control methodologies. For example, in some exemplary embodiments the controller 710 can use a desired running average for the heat and/or power input over a set duration or distance and adjust the waveform 800 to maintain that desired running average. In such embodiments a joules/sec or joules/in ratio can be used for the control, where the predetermined running average is set based on user input information.

For example, in some exemplary embodiments an offset ratio of arc process joules to hot wire process joules can be used for system control. For example, the system controller can determine a desired or predetermined heat input ratio can be determined and the process is controlled to achieve the desired ratio over a given time, or over a running average. In exemplary embodiments, the determined arc process joules to hot wire process joules ratio is in the range of 2.5:1 to 10:1. In other exemplary embodiments the ratio is in the range of 3:1 to 7:1.

FIG. 8B depicts another exemplary embodiment of a waveform 800′ which is similar to the waveform 800 in FIG. 8A. However, in this embodiment the hot wire portion 820′ of the waveform 800′ has a negative polarity, and thus the overall waveform 800′ is an AC type waveform. It is noted that during some welding operations, the constant use of the same current polarity can magnetize a workpiece and/or the workpiece fixtures. This can be undesirable for a number of reasons. However, by alternating the current as shown in FIG. 8B the buildup of magnetics can be mitigated and minimized. Generally, the waveform 800′ is generated and controlled in a similar fashion to that discussed above regarding FIG. 8A, but as shown the hot wire portion has a negative polarity. Unlike with arc welding, the use of a negative polarity will have little effect on the overall heat input of the welding operation, because no arc is present. In fact, in some exemplary embodiments the power supply can use a combination of both of the waveforms shown in FIGS. 8A and 8B. That is, the hot wire portion of a current waveform can alternate between a positive and negative polarity and need not have the same polarity for the entire welding process. AC current has a degaussing effect to the fixture and the frequency of the AC is related to this effect. Thus, in some exemplary embodiments, the polarity is changed to optimize the degaussing effect. In some embodiments, consecutive pulses alternate in polarity. Further, the welding process can use a plurality of consecutive hot wire portions having a first polarity (e.g., positive) followed by a single (or a plurality of) hot wire portion having a second polarity (e.g., negative). The controller/power supply can adjust the polarity of the hot wire portions as needed to achieve the desired performance, while preventing the buildup of magnetic forces in the workpiece/fixtures. Further, not only can the polarity change for the hot wire portions, but can also be changed for the arc welding portions 810 of the waveforms 800/800′. That is, embodiments of the present invention can also employ AC arc welding processes for the arc welding portions 810. Further, other embodiments can employ negative polarity arc welding, while using positive polarity hot wire welding—the opposite of what is shown in FIG. 8B.

In further exemplary embodiments, the controller 710 can be coupled to a magnetic sensor which detects the buildup of magnetic fields in the workpiece and/or a fixture holding the workpiece. Based on feedback from this magnetic sensor the controller 710 can control the power supply to adjust the polarity of the hot wire portions 820/820′ to mitigate or control the buildup any undesirable magnetic forces.

FIG. 9 depicts another exemplary embodiment of a waveform 900 which is similar to the waveform 800 shown in FIG. 8A. However, in this embodiment the power supply transitions quickly from the hot wire portion 820 to the arc welding portion 810 of the waveform. As shown, in this embodiment the hot wire current is reduced to a transition level 901 which is less than the peak of the hot wire current (810) or the peak of the arc welding pulses 802, but higher than the background current 803. When the current reaches the transition level 901 the power supply switches from an arc suppression mode of operation to a traditional arc generation mode of operation and an arc is immediately created. Such embodiments can be employed when using high wire feed speeds to prevent the consumable from bottoming out in the puddle while transitioning from the hot wire process to the arc welding process. In exemplary embodiments the transition level is in the range of 100 to 250 amps. In other exemplary embodiments, the transition can use a ramped current to minimize the chance of an explosion or spatter event during the creation of the arc. Other embodiments could also retract or slow the wire during transition. In yet further exemplary embodiments, an STT control approach can be used where a premonition circuit is used to reduce the current just prior to the creation of the arc. Additionally, other embodiments can use a peak current independent of the process current to establish a gap between the puddle and the consumable just after the arc is created. Further, other exemplary embodiments can utilize an extended background current when transition from the arc welding process to the hot wire process. The extended background would encourage a short circuit event and when the short occurs the transition to hot wire can be initiated.

Of course, it should be noted that other transition waveforms and control methodologies can be used to change from the hot wire portion 820 to an arc welding portion 810 of the waveforms 800/800′/900.

In exemplary embodiments of the present invention, the wire feed speed of the consumable can also be adjusted during the process to optimize the process. For example, in exemplary embodiments the wire feed speed during the arc welding phase can be slower than that during the hot wire process. For example, if a short arc welding process is used in the arc welding phase the wire feed speed will be slowed during the transition from hot wire to arc welding, and then sped up when transitioning back to the hot wire process.

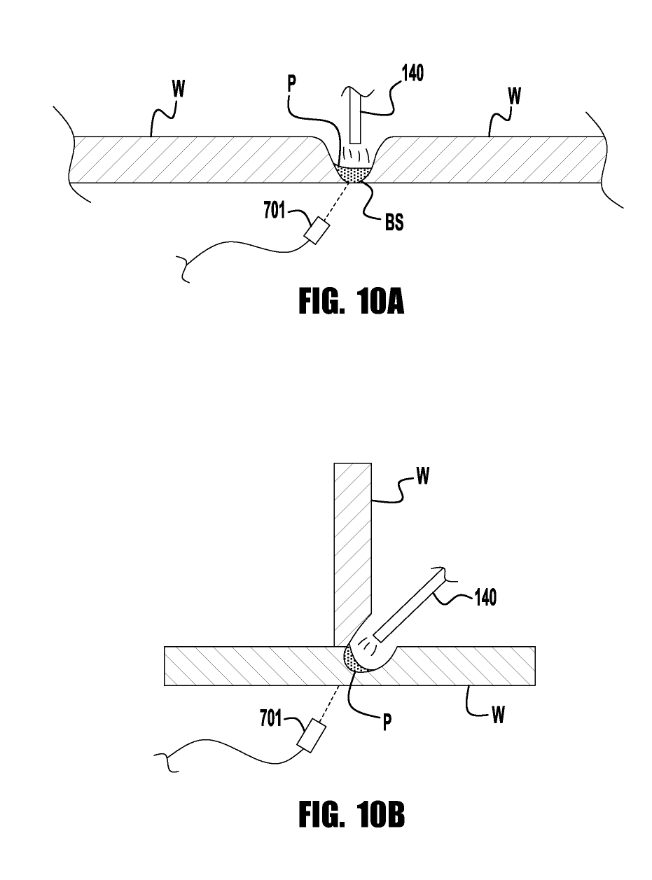

Because embodiments of the present invention provide enhanced heat control, they can be used to optimize welding operations. For example, embodiments of the present invention can be used to weld joints such as butt joints and T joints without the need for backing, especially on relatively thin workpieces. This is generally depicted in FIGS. 10A and 10B. FIG. 10A depicts a butt joint where the backside BS of the weld is not using a backer plate to support the weld. Because embodiments of the present invention have enhanced heat control, this weld can be completed without a backer and without the weld puddle blowing through the backside BS of the weld. In exemplary embodiments, the arc welding process can be used to add heat to the weld and provide the desired penetration, then the hot wire portion of the welding process can be used to add material without over heating (or even cooling) the process so that the puddle will not come through the backside of the joint. This greatly enhances the productivity of welding operations. Further, in additional exemplary embodiments of the present invention a sensor 701 (for example, a thermal sensor) can be positioned so as to monitor the backside BS of a weld joint and feedback from the sensor 701 is used to control the output of the power supply 310 so as to achieve the desired heat input and deposition. That is, the feedback from the sensor 701 can be used to control the ratio of hot wire process to arc welding process which is output from the power supply. For example, if an undesirable temperature increase is detected on the backside BS of the weld, the power supply will switch to hot wire so as to cool the process and prevent the puddle from penetrating the backside of the weld. Similarly, embodiments of the present invention can be used to weld a T joint like that shown in FIG. 10B without the use of a backing. Of course, embodiments of the present invention are not limited to just these types of joints but can be used on many different joint types.

Further, embodiments of the present invention also provide for improved welding on coated workpieces, such as galvanized. It is generally known that traditional welding of galvanized materials requires the removal of the coating prior to welding and/or welding very slowly so as to prevent the weld joint from becoming too porous. However, embodiments of the present invention can be used to join coated/galvanized workpieces without these drawbacks. That is, by using a combination of arc welding and hot wire welding with the same consumable a weld joint can be created at an improved rate while minimizing porosity in the joint. The arc welding process can be used to penetrate the workpiece and vaporize the coating, while the hot wire process can keep the overall heat input low and prevent the vaporization of any coating (e.g., zinc) in the heat affected zone of the weld. In exemplary embodiments of the present invention, the ratio of arc welding duration to hot wire duration is in the range of 70/30 to 40/60 when welding coated workpieces. In further embodiments, the ratio is in the range of 60/40 to 45/55. Thus, embodiments of the present invention can be used to achieve improved performance over known welding methodologies when welding coating materials.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the present application.

We claim:

1. A consumable deposition system, comprising:
a power supply which provides a current waveform to a consumable to be deposited into a molten puddle on at least one workpiece, said current waveform comprising:
an arc deposition portion which results in an arc between said consumable and said puddle; and
a hot wire portion during which a heating current is provided to said consumable and no arc is created between said consumable and said puddle;
wherein said power supply includes a controller which determines a desired heat input into said at least one workpiece from said current waveform and said power supply alternates said current waveform between said arc deposition portion and said hot wire portion to control said heat input into said workpiece from said current waveform to maintain said desired heat input.

2. The deposition system of claim 1, wherein said arc deposition portion is a GMAW type process.

3. The deposition system of claim 1, further comprising a sensor which detects a heat input into said workpiece and said controller uses feedback from said sensor to control said power supply and alternate said current waveform between said arc deposition portion and said hot wire portion.

4. The deposition system of claim 1, wherein said controller controls said current waveform such that a ratio of said hot wire portion to said arc deposition portion of said current waveform is in the range of 50/50 to 0/100.

5. The deposition system of claim 1, wherein said controller controls a ratio of said hot wire portion to said arc deposition portion of said current waveform to maintain said desired heat input.

6. The deposition system of claim 1, wherein said controller controls at least one of a frequency and a number of current pulses in at least one of said hot wire portion and said arc deposition portion to maintain said desired heat input.

7. The deposition system of claim 1, wherein said desired heat input is a running average heat input for said current waveform.

8. The deposition system of claim 1, wherein said desired heat input is determined based on at least one of, or a combination of, a material type of said workpiece; a type of said consumable; a weld size, a weld position, an application type, a gap size to be filled, a wire feed speed for said consumable and a thickness of said workpiece.

9. The deposition system of claim 1, wherein said desired heat input is a running average power input for said current waveform.

10. The deposition system of claim 1, wherein said controller controls said current waveform such that a ratio of joules of said arc deposition process to joules of said hot wire process is in the range of 2.5:1 to 10:1.

11. The deposition system of claim 1, wherein said controller controls said current waveform such that a ratio of joules of said arc deposition process to joules of said hot wire process is in the range of 3:1 to 7:1.

12. A consumable deposition method, comprising:
generating and delivering a deposition current to a consumable;
advancing said consumable towards a workpiece to deposit said consumable on said workpiece using said deposition current;
wherein said generating current waveform comprises:
generating an arc deposition portion which results in an arc between said consumable and said puddle; and
generating a hot wire portion during which a heating current is provided to said consumable and no arc is created between said consumable and said puddle; and
determining a desired heat input into said at least one workpiece from said current waveform and alternating said current waveform between said arc deposition portion and said hot wire portion to control said heat input into said workpiece from said current waveform to maintain said desired heat input.

13. The deposition method of claim 12, wherein said arc deposition portion is a GMAW type process.

14. The deposition method of claim 12, further comprising sensing a heat input into said workpiece and using feedback from said sensor to control said alternating between said arc deposition portion and said hot wire portion.

15. The deposition method of claim 12, further comprising controlling said current waveform such that a ratio of said hot wire portion to said arc deposition portion of said current waveform is in the range of 50/50 to 0/100.

16. The deposition method of claim 12, further comprising controlling a ratio of said hot wire portion to said arc deposition portion of said current waveform to maintain said desired heat input.

17. The deposition method of claim 12, further comprising controlling at least one of a frequency and a number of current pulses in at least one of said hot wire portion and said arc deposition portion to maintain said desired heat input.

18. The deposition method of claim 12, wherein said desired heat input is a running average heat input for said current waveform.

19. The deposition method of claim 12, wherein said desired heat input is determined based on at least one of, or a combination of, a material type of said workpiece; a type of said consumable; a weld size, a weld position, an application type, a gap size to be filled, a wire feed speed for said consumable and a thickness of said workpiece.

20. The deposition method of claim 12, wherein said desired heat input is a running average power input for said current waveform.

21. The deposition method of claim 12, wherein said controller controls said current waveform such that a ratio of joules of said arc deposition process to joules of said hot wire process is in the range of 2.5:1 to 10:1.

22. The deposition method of claim 12, wherein said controller controls said current waveform such that a ratio of joules of said arc deposition process to joules of said hot wire process is in the range of 3:1 to 7:1.
